(19) United States
(12) Patent Application Publication
(10) Pub. No.: US 2017/0324078 A1
(43) Pub. Date: Nov. 9, 2017

(54) APPARATUS AND METHOD FOR MAKING LITHIUM IRON PHOSPHATE

(71) Applicants: Jiangsu Huadong Institute of Li-Ion Battery Co., Ltd., Suzhou (CN); Tsinghua University, Beijing (CN)

(72) Inventors: LI WANG, Beijing (CN); XIANG-MING HE, Beijing (CN); JING LUO, Suzhou (CN); CHENG-HAO XU, Beijing (CN); JIAN-JUN LI, Beijing (CN); DAN LV, Suzhou (CN); YU-MING SHANG, Beijing (CN); HONG-SHENG ZHANG, Suzhou (CN)

(73) Assignees: Jiangsu Huadong Institute of Li-Ion Battery Co., L td., Suzhou (CN); Tsinghua University, Beijing (CN)

(21) Appl. No.: 15/659,625

(22) Filed: Jul. 26, 2017

Related U.S. Application Data
(63) Continuation of application No. PCT/CN2015/096268, filed on Dec. 3, 2015.

(30) Foreign Application Priority Data
Jan. 28, 2015 (CN) 201510042750.X

(51) Int. Cl. H01M 4/04; H01M 4/58; H01M 4/38; C01B 25/45; B01F 15/00; H01M 4/76; B01F 7/00; B01F 3/00

(52) U.S. Cl. CPC H01M 4/0438; H01M 4/765; H01M 4/5825; H01M 4/382; B01F 7/00241; C01B 25/45; H01M 4/0471; B01F 15/00357; B01F 2003/0007

(57) ABSTRACT

An apparatus and a method for making lithium iron phosphate are disclosed. The apparatus comprises a raw material system to provide a raw material mixed solution of raw materials of a hydrothermal reaction or a solvothermal reaction; a tubular reaction device to make the raw material mixed solution in a plug flowing and reacting state to obtain a reacted material; and a kettle reaction device to make the reacted material in a complete mixing and reacting state to obtain a product. The method comprises providing a raw material mixed solution of raw materials of a hydrothermal reaction or a solvothermal reaction; making the raw material mixed solution in a plug flowing and reacting state to obtain a reacted material; and making the reacted material in a complete mixing and reacting state. The lithium iron phosphate can be continuously produced by the apparatus and method.

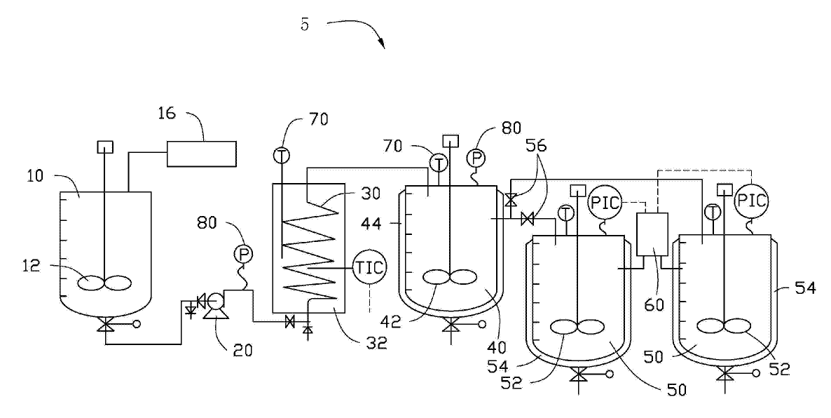

### CROSS-REFERENCE TO RELATED APPLICATIONS

This application claims all benefits accruing under 35 U.S.C. §119 from China Patent Application No. 201510042750.X, filed on Jan. 28, 2015 in the State Intellectual Property Office of China, the content of which is hereby incorporated by reference. This application is a continuation under 35 U.S.C. §120 of international patent application PCT/CN2015/096268 filed on Dec. 3, 2015, the content of which is also hereby incorporated by reference.

### FIELD

The present disclosure relates to an apparatus and a method for continuously making lithium iron phosphate.

### BACKGROUND

Energy issue is an important problem in development of human society and science technology. Lithium ion battery as a green secondary battery with relatively high energy density has been widely used in consumer electronic products such as laptops, mobile phones, and cameras.

Lithium iron phosphate has drawn a great attention as a cathode active material of the lithium ion battery due to its safety, low production cost, and environmental friendly. High temperature solid phase method, spraying method, hydrothermal synthesis method, solvothermal synthesis method, coprecipitation method, emulsion drying method, and microwave synthesis method are main methods for synthesizing lithium iron phosphate in the laboratory. The high temperature solid phase method is the mostly used method for a large-scale synthesizing of lithium iron phosphate in the industry. However, the high temperature solid phase method uses a high temperature to sinter the lithium iron phosphate, which induces a large particle size and poor electrochemical performance. The hydrothermal synthesis method and the solvothermal synthesis method can be used to synthesize the lithium iron phosphate with a small particle size at a low temperature. However, the raw materials need to be reacted in a sealed autoclave to obtain the lithium iron phosphate. A yield of the lithium iron phosphate is limited by a volume of the sealed autoclave. Not only is a large-scale production of the lithium iron phosphate difficult to realize, but also an electrochemical performance of the lithium iron phosphate synthesized in different batches are prone to be affected by synthesis condition change.

### SUMMARY

One embodiment of an apparatus for continuously making lithium iron phosphate by a hydrothermal synthesis or a solvothermal synthesis comprises a raw material system, a material transport system, a tubular reaction device, a kettle reaction device, a pressure regulating system, and a discharge system. The raw material system is configured to mix raw materials to obtain a raw material mixed solution. The material transport system is configured to transport the raw material mixed solution into the tubular reaction device. The tubular reaction device is configured to keep the raw material mixed solution in a plug flowing and reacting state at a predetermined temperature under a predetermined pressure for a first predetermined time to obtain a reacted material. The kettle reaction device is disposed next to the tubular reaction device and configured to keep the reacted material in a complete mixing and reacting state at the predetermined temperature under the predetermined pressure for a second predetermined time to obtain a product, and transport the product into the discharge system. The pressure regulating system is configured to keep the pressure inside the tubular reaction device and the pressure inside the kettle reaction device substantially equal to the predetermined pressure by adding a solvent into a reaction system of the hydrothermal synthesis or the solvothermal synthesis.

An embodiment of a method for making lithium iron phosphate by the hydrothermal synthesis or the solvothermal synthesis comprises steps of:

mixing the raw materials uniformly to obtain the raw material mixed solution;

transporting the raw material mixed solution into the tubular reaction device;

keeping the raw material mixed solution in the plug flowing and reacting state at the predetermined temperature under the predetermined pressure in the tubular reaction device, and taking the first predetermined time for the raw material mixed solution flowing from an inlet to an outlet of the tubular reaction device to obtain the reacted material; transporting the reacted material into the kettle reaction device, stirring the reacted material at the predetermined temperature under the predetermined pressure to keep the reacted material in the complete mixing and reacting state in the kettle reaction device for the second predetermined time to obtain the product, and transporting the product into the discharge system; and

regulating a pressure of the reaction system by introducing the solvent with a higher vapor pressure into the reaction system to increase a percentage of the solvent with the higher vapor pressure.

In the present disclosure, the hydrothermal synthesis and the solvothermal synthesis can comprise two reaction stages. A first reaction stage is a plug flowing and reacting stage, and the next reaction stage is a complete mixing and reacting stage. At the beginning of the hydrothermal reaction or the solvothermal reaction, the reaction system is unstable, and a condition inside the reaction system varies. The plug flowing and reacting stage sets a controllable flowing direction for the materials at the beginning of the reaction to avoid backward flowing or mixing. At the end of the hydrothermal reaction or the solvothermal reaction, the reaction system is stable, and the condition inside the reaction system is substantially unchanged. The complete mixing and reacting stage uses a kettle reaction device to precisely control the reaction conditions to provide a uniform condition for the material at the end of the reaction. The lithium iron phosphate with stable electrochemical performance and high consistency can be continuously produced by the apparatus and the method. The pressure of the reaction system can be precisely regulated by a cooperation between the pressure regulating system and the kettle reaction device.

### BRIEF DESCRIPTION OF THE DRAWINGS

Implementations are described by way of example only with reference to the attached FIGURES.

The FIGURE is a schematic view of one embodiment of an apparatus for making lithium iron phosphate.

### DETAILED DESCRIPTION

A detailed description with the above drawings is made to further illustrate the present disclosure.

Referring to the FIGURE, one embodiment of an apparatus 5 for continuously making lithium iron phosphate by a hydrothermal synthesis or a solvothermal synthesis comprises a raw material system, a material transport system, a tubular reaction device, a kettle reaction device, a pressure regulating system, and a discharge system.

The raw material system is configured to prepare a raw material mixed solution for the hydrothermal synthesis or the solvothermal synthesis, for example, by mixing and dissolving a phosphorus source, a lithium source, and a ferrous source into a first solvent. The material transport system is configured to continuously transport the raw material mixed solution into the tubular reaction device with an adjustable input speed. The tubular reaction device is configured to make the raw material mixed solution in a plug flowing and reacting state at a predetermined temperature under a predetermined pressure for a first predetermined time to obtain a reacted material. The kettle reaction device is located next to the tubular reaction device. The kettle reaction device is configured to make the reacted material in a complete mixing and reacting state at the predetermined temperature under the predetermined pressure for a second predetermined time to obtain a product, and continuously transport the product into the discharge system. The pressure regulating system is configured to keep a first pressure inside the tubular reaction device and a second pressure inside the kettle reaction device substantially equal to the predetermined pressure by adding a second solvent into the reaction system of a hydrothermal reaction or a solvothermal reaction.

The raw material system can comprise a mixing device. The mixing device is configured to mix the raw materials uniformly in the first solvent to obtain the raw material mixed solution. The mixing device can comprise a mixing container 10 and a first stirrer 12. The first stirrer 12 can be located in the mixing container 10. The first stirrer 12 can be a stirring shaft having a stirring paddle disposed thereon. A first rotating speed of the first stirrer 12 can be in a range from 0 to about 1470 revolutions per minute (rpm). A first outlet of the mixing container 10 can be defined on a bottom wall or a side wall of the mixing container 10. In one embodiment, the first outlet of the mixing container 10 is defined on the side wall of the mixing container 10. The raw material mixed solution can be output from the first outlet by a centrifugal force generated from a revolution of the first stirrer 12. In another embodiment, the first outlet of the mixing container 10 is defined on the bottom wall of the mixing container 10. The raw material mixed solution can be output from the first outlet by the gravity. The mixing container 10 can be a sealed container into which a protective gas can be introduced to protect the raw material mixed solution. A working temperature in the mixing container 10 can be room temperature. A working pressure in the mixing container 10 can be an atmospheric pressure. A residence time of the raw materials in the mixing container 10 can be dependent on an input speed of the raw materials and an output speed of the raw material mixed solution.

The raw material system can further comprise a raw material container 16. The raw material container 16 is configured to store the solutions of raw materials. In one embodiment, the raw material container 16 can comprise a first raw material container and a second raw material container. The solutions can comprise a reacted solution of phosphoric acid and lithium hydroxide, and a ferrous phosphate solution. The first raw material container is configured to store the reacted solution. The second raw material container is configured to store the ferrous phosphate solution. The solutions can be input into the mixing container 10 from the raw material container 16 through a first inlet of the mixing container 10.

In the raw material system, there is no reaction carried out in the raw material mixed solution, or only a pre-reaction is carried out in the raw material mixed solution to produce an intermediate product or a precursor of the lithium iron phosphate. The lithium iron phosphate cannot be produced in the raw material system.

The tubular reaction device can comprise a first heating device 32 and a continuous tubular reactor (CTR) 30. The first heating device 32 is configured to heat the CTR 30. The first pressure inside the CTR 30 can be kept different from an external pressure of the CTR 30. The first predetermined time can be equal to or no longer than 4 hours, such as about 1 hour. A length (L) of the CTR 30 can be decided according to the first predetermined time (t) and a flow rate (u) of the raw material mixed solution in the CTR 30. That is, L=u×t. The flow rate of the raw material mixed solution in the CTR 30 is dependent on the input speed of the material transport system. An inner radius of the CTR 30 can be in a range from about 5 mm to about 20 mm. A first temperature inside the CTR 30 during working can be in a range from about 0° C. to about 250° C. The first pressure in the CTR 30 during working can be in a range from about 0 MPa to about 2 MPa. The first heating device 32 can comprise a constant temperature oil bath and a heater. The constant temperature oil bath can be heated by the heater. An oil temperature of the constant temperature oil bath can be kept constant by the heater. The CTR 30 can be a curved tube located in the constant temperature oil bath to save an installation space.

The raw material mixed solution can be heated under the predetermined pressure in the CTR 30. The CTR 30 can provide an environment with a constant temperature and a constant pressure in which the hydrothermal reaction or the solvothermal reaction can be carried out in the raw material mixed solution. A first stage of the hydrothermal reaction or the solvothermal reaction (generally referring to a reaction process in the first several hours, such as 4 hours, of the hydrothermal reaction or the solvothermal reaction) can occur in the CTR 30 during which the reaction system of the hydrothermal reaction or the solvothermal reaction is unstable, and a condition inside the reaction system is inconstant. By keeping the raw material mixed solution in the plug flowing and reacting state in the CTR 30, a backward flowing and mixing of the raw material mixed solution can be eliminated, and the hydrothermal reaction or the solvothermal reaction can be controllable in the first stage, thereby the hydrothermal reaction or the solvothermal reaction can be carried out according to a predetermined reaction mode, lithium iron phosphate particles produced by the hydrothermal reaction or the solvothermal reaction cannot be aggregated, and maturing times of the lithium iron phosphate particles can be substantially the same to obtain the uniform lithium iron phosphate particles.

The raw material mixed solution can be continuously transported into the tubular reaction device from the mixing container 10 by the material transport system. The material transport system can comprise a delivery pump 20 located between the mixing container 10 and the CTR 30. The delivery pump 20 can be respectively connected to the first outlet of the mixing container 10 and a second inlet of the CTR 30. The delivery pump 20 is configured to transport the raw material mixed solution into the CTR 30 from the mixing container 10, regulate the flow rate of the raw material mixed solution, and control a passing time that the raw material mixed solution passing through the CTR 30. The delivery pump 20 can be a metering pump. A rated flow of the delivery pump 20 can be equal to or smaller than 10 liters per hour. The flow rate of the raw material mixed solution can be regulated by a frequency converter. An exit pressure of the delivery pump 20 can be in a range from 0 MPa to about 2 MPa.

The kettle reaction device can comprise a continuously stirred tank reactor (CSTR) 40, a second stirrer 42, and a second heating device 44. A third inlet of the CSTR 40 can be connected to the second outlet of the CTR 30 by an air-tight tube. The second stirrer 42 can be located in the CSTR 40. The second stirrer 42 can be a stirring shaft having a stirring paddle disposed thereon. A second rotating speed of the second stirrer 42 can be in a range from 0 to about 1470 rpm. The second heating device 44 can be located outside the CSTR 40 to heat the CSTR 40 and keep a second temperature inside the CSTR 40 constant. The second heating device 44 can be a heating jacket surrounded an outer wall of the CSTR 40. The second pressure inside the CSTR 40 can be kept different from an external pressure of the CSTR 40. The second temperature in the CSTR 40 during working can be in a range from about 0° C. to about 250° C. The second pressure in the CSTR 40 during working can be in a range from about 0 MPa to about 2 MPa. The second predetermined time can be in a range from about 1 hour to about 10 hours. A third outlet of the CSTR 40 can be defined on a side wall of the CSTR 40. The product can be continuously transported from the CSTR 40 into the discharge system through the third outlet by a centrifugal force generated from a revolution of the second stirrer 42. An outlet valve can be located on the bottom of the CSTR 40 to control an output of the product from the CSTR 40.

A second stage of the hydrothermal reaction or the solvothermal reaction (generally referring to a reaction process in the last several hours of the hydrothermal reaction or the solvothermal reaction) can occur in the CSTR 40 during which the reaction system of the hydrothermal reaction or the solvothermal reaction is stable, and the condition of the reaction system is substantially unchanged. The CSTR 40 has advantages of low cost, easy operation, convenient cleaning, and easy maintenance. Reaction parameters in the CSTR 40 are easy to regulate in the complete mixing and reacting state, thereby the lithium iron phosphate in different batches with good consistency and high stability can be continuously produced. The second pressure inside the CSTR 40 is easier to regulate, for example by adding the second solvent.

The discharge system can comprise at least two kettle containers 50. The at least two kettle containers 50 can be switched to receive the product. The at least two kettle containers 50 can be respectively connected to the third outlet of the CSTR 40. An internal pressure different from an external pressure of each kettle container 50 can be maintained. When communicating with the CSTR 40, a third pressure inside the kettle container 50 can be substantially the same as the second pressure inside the CSTR 40. The discharge system can further comprise at least two inlet valves 56. The at least two kettle containers 50 can be respectively and independently connected to the CSTR 40 by at least two inlet valves 56. During working, only one inlet valve 56 is open, and the other inlet valves 56 are closed. The at least two kettle containers 50 can be switched to receive the product by controlling the at least two inlet valves 56. When one inlet valve 56 is closed, the product in the kettle container 50 connected to the closed inlet valve 56 can be discharged from the kettle container 50 without influencing the reaction parameters in the CSTR 40.

The discharge system can further comprise at least two third heating devices 54 to respectively heat the at least two kettle containers 50, and keep a third temperature inside each kettle container 50 substantially equal to the second temperature inside the CSTR 40, by which a mass percentage of the first solvent in the reacted material inside the CSTR 40 can be substantially equal to a mass percentage of the first solvent in the product inside the kettle container 50. Each heating device 54 can be located outside each kettle container 50 to heat the kettle container 50, and keep the third temperature inside the kettle container 50 constant. Each heating device 54 can be a heating jacket surrounded an outer wall of the kettle container 50. The third temperature inside the kettle container 50 during working can be in a range from about 0° C. to about 250° C. The third pressure inside the kettle container 50 during working can be in a range from about 0 MPa to about 2 MPa. When heating the kettle container 50, the third pressure inside the tank container 50 can be generated from an evaporation of the first solvent.

The discharge system can further comprise at least two third stirrers 52 respectively located in the at least two kettle containers 50. Each third stirrer 52 can be a third stirring shaft having a third stirring paddle disposed thereon. A third rotating speed of each third stirrer 52 can be in a range from 0 to about 200 rpm.

Each kettle container 50 can further comprise a gas exhausting device (not shown), such as a needle valve to control the third pressure inside the kettle container 50.

The product can be continuously input into the discharge system and intermittently output from the discharge system. The at least two kettle containers 50 can be alternately used to receive the product and output the product, during which the hydrothermal reaction or the solvothermal reaction in the CSTR 40 cannot be influenced.

The apparatus 5 can further comprise at least one temperature measuring device 70, such as at least one thermocouple. The least one temperature measuring device 70 can be disposed on the mixing device, the tubular reaction device, the kettle reaction device and/or the discharge system to monitor temperatures of different devices. The temperatures of the different devices can be regulated by a control system.

The CTR 30, the CSTR 40, and one kettle container 50 can be communicated with each other during the hydrothermal synthesis or the solvothermal synthesis, so the first pressure, the second pressure, and the third pressure are substantially the same. The first pressure, the second pressure, and the third pressure can be generated from the evaporation of the first solvent. The apparatus 5 can further comprise at least one pressure measuring device 80 to motor pressures of the different devices. The at least one pressure measuring device 80 can be disposed inside the mixing container 10, on the outlet of the delivery pump 10 or on the second inlet of CSTR 30, inside the CSTR 40, and inside the kettle container 50.

During working or operation, when an inner pressure of the apparatus 5 is unexpectedly decreased, for example, by accidental communication of the apparatus 5 with an external environment, the predetermined pressure of the reaction system is difficult to recover simply by a continuous input of the raw material mixed solution, thereby making the reaction system unstable and the lithium iron phosphate non-uniform. The second solvent can be introduced into the reaction system by the pressure regulating system to keep the predetermined pressure and maintain a pressure equilibrium of the reaction system. A vapor pressure of the second solvent can be larger than a vapor pressure of the first solvent at the predetermined temperature. That is, the second solvent can be more volatile than the first solvent. In one embodiment, the first solvent can be ethylene glycol or a mixture solvent of water and ethylene glycol. The second solvent can be water. When the lithium iron phosphate is made by the hydrothermal synthesis, the vapor pressure of the second solvent can be larger than a vapor pressure of water at the predetermined temperature. According to Raoult's law, a vapor pressure of the reaction system is dependent on solvent component of the reaction system. By adding the second solvent with higher vapor pressure, a pressure of the reaction system can be increased.

In one embodiment, the second solvent can be directly introduced into the CSTR 40 by the pressure regulating system. In another embodiment, the second solvent can be introduced into the discharge system, such as the kettle container 50 communicating with the CSTR 40. Because the CTR 30, the CSTR 40, and the tank container 50 are communicated with each other, by introducing the second solvent into the kettle container 50, the pressure of the reaction system of the apparatus 5 can be regulated without change a reaction medium (i.e. the first solvent) of the hydrothermal reaction or the solvothermal reaction.

The pressure regulating system can comprise an injection device 60. In one embodiment, the injection device 60 is connected to the CSTR 40 to introduce the second solvent into the CSTR 40. In another embodiment, the at least two kettle containers 50 can be respectively connected to the injection device 60. The injection device 60 is configured to introduce the second solvent into the at least two kettle containers 50. An amount of the second solvent introduced into the at least two kettle containers 50 can be decided according to the third pressure inside the at least two kettle containers 50. The second solvent is evaporated in the at least two kettle containers 50 to compensate the decreased pressure and recover the predetermined pressure, thereby ensuring the uniformity of the lithium iron phosphate. When the predetermined temperature is kept steady, and a component of the first solvent is definite, the pressure of the reaction system can be precisely controlled by adding the second solvent.

The apparatus 5 can further comprise control valves at different places to control the apparatus 5 and for inspection and repair the apparatus 5 section by section.

One embodiment of a method for making lithium iron phosphate by the apparatus 5 comprises steps of:

S1, mixing the raw materials uniformly in the first solvent to obtain the raw material mixed solution;

S2, transporting the raw material mixed solution into the tubular reaction device;

S3, making the raw material mixed solution in the plug flowing and reacting state at the predetermined temperature under the predetermined pressure in the tubular reaction device, and taking the first predetermined time for the raw material mixed solution from flowing into the CTR 30 through the second inlet to flowing out the CTR 30 through the second outlet to obtain the reacted material;

S4, transporting the reacted material into the kettle reaction device, stirring the reacted material at the predetermined temperature under the predetermined pressure to make the reacted material in the complete mixing and reacting state in the kettle reaction device for the second predetermined time to obtain the product, and transporting the product into the discharge system; and

S5, regulating the pressure of the reaction system by introducing the second solvent with higher vapor pressure into the reaction system.

In S1, the solutions of the raw materials can be transported into the mixing tank 10 and stirred by the first stirrer 12 uniformly to obtain the raw material mixed solution. The solutions can comprise a reacted solution of the phosphorus source and the lithium source, and a ferrous source solution. The first solvent contained in the raw material mixed solution can be water, an organic solvent, or combinations thereof. The solutions can be stirred and mixed at the room temperature under the atmospheric pressure. The solutions can be stirred and mixed in the protective gas to protect the raw material mixed solution.

In S2, the raw material mixed solution can be continuously transported into the tubular reaction device by the material transport device. The flow rate of the raw material mixed solution can be regulated by the material transport device to cause the raw material mixed solution passing through the tubular reaction device at the first predetermined time.

In S3 and S4, the lithium iron phosphate can be obtained at the predetermined temperature under the predetermined pressure during the hydrothermal synthesis or the solvothermal synthesis. A plurality of lithium iron phosphate crystalline grains can be formed and grown in the tubular reaction device and kettle reaction device to obtain the lithium iron phosphate with uniform particle size and stable electrochemical performance. A time for synthesizing the lithium iron phosphate is equal to a sum of the first predetermined time and the second predetermined time. The first predetermined time can be equal to or no longer than 4 hours, such as 1 hour. The second predetermined time can be in a range from about 1 hour to about 10 hours.

The product of the hydrothermal synthesis or the solvothermal synthesis can be transported into the discharge system. The product can be continuously input into the discharge system and intermittently output from the discharge system, thereby not only the lithium iron phosphate can be continuously produced, but an influence of the output of the lithium iron phosphate on the reaction system of the lithium iron phosphate can be controllable and minimized.

In one embodiment, two kettle containers 50 can be provided and respectively connected to the third outlet of the CSTR 40. Each kettle container 50 can comprise an independent inlet valve 52. When outputting the product, the inlet valve 52 of one kettle container 50 can be opened, and the inlet valve 52 of the other kettle container 50 can be closed, during which the product in the CSTR 40 can be transported into the kettle container 50 wherein the inlet valve 52 is opened, the other kettle container 50 wherein the inlet valve 52 is closed can be separated from the CSTR 40 to output the product, by which the reaction system cannot be effected.

In S5, when the pressure of the reaction system is decreased, the second solvent can be introduced into the reaction system according to a reduction of the pressure of the reaction system. The second solvent can be introduced to the CSTR 40 and/or the kettle container 50 to compensate the decreased pressure of the reaction system. The reduction of the pressure of the reaction system can be measured by the pressure measuring device 80 located in the CSTR 40 and/or the kettle container 50. The amount of the second solvent introduced into the CSTR 40 and/or the kettle container 50 can be calculated by Raoult's law. The second solvent can be introduced into the CSTR 40 and/or the kettle container 50 by the injection device 60 to maintain the predetermined pressure and keep pressure equilibrium of the reaction system.

In the present disclosure, the hydrothermal synthesis and the solvothermal synthesis can comprise two reaction stages. One reaction stage is a plug flowing and reacting stage, and the other reaction stage is a complete mixing flow reaction stage. The first stage of the hydrothermal reaction or the solvothermal reaction, during which the reaction system of the hydrothermal reaction or the solvothermal reaction is unstable, and a reaction condition inside the reaction system is inconstant, can be occurred in the plug flowing and reacting stage to avoid backmixing. The second stage of the hydrothermal reaction or the solvothermal reaction, during which the reaction system of the hydrothermal reaction or the solvothermal reaction is stable, and the reaction condition inside the reaction system is substantially unchanged, can be occurred in the complete mixing flow reaction stage to precisely control the reaction conditions. The lithium iron phosphate with stable electrochemical performance and high consistency can be continuously produced by the apparatus. The pressure of the reaction system can be precisely regulated by the pressure regulating system and the CSTR.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An apparatus for making lithium iron phosphate, comprising:
a raw material system to provide a raw material mixed solution of a hydrothermal reaction or a solvothermal reaction;
a tubular reaction device to make the raw material mixed solution in a plug flowing and reacting state to obtain a reacted material; and
a kettle reaction device to make the reacted material in a complete mixing and reacting state to obtain a product.

2. The apparatus of claim 1, wherein the tubular reaction device comprises:
a continuous tubular reactor to make the raw material mixed solution in the plug flowing and reacting state; and
a first heating device to heat the continuous tubular reactor.

3. The apparatus of claim 2, wherein the continuous tubular reactor is configured to make the raw material mixed solution in a plug flowing and reacting state at a predetermined temperature under a predetermined pressure for a first predetermined time to obtain the reacted material.

4. The apparatus of claim 3, wherein a length of the continuous tubular reactor is decided according to the first predetermined time and a flow rate of the raw material mixed solution in the continuous tubular reactor.

5. The apparatus of claim 1, wherein the product is lithium iron phosphate.

6. The apparatus of claim 1, wherein the kettle reaction device comprises:
a continuously stirred tank reactor to receiving the reacted material;
a stirrer to stir the reacted material; and
a second heating device to heat the continuously stirred tank reactor.

7. The apparatus of claim 6, wherein an outlet is defined on a side wall of the continuously stirred tank reactor to output the product by a centrifugal force generated from a revolution of the stirrer.

8. The apparatus of claim 1, wherein a first pressure inside the tubular reaction device is substantially the same as a second pressure inside the kettle reaction device.

9. The apparatus of claim 1, further comprising a discharge system to receive the product, the discharge system comprises at least two kettle containers respectively connected to the kettle reaction device, the at least two kettle containers are configured to alternately receive the product.

10. The apparatus of claim 9, wherein the at least two kettle containers are respectively connected to the kettle reaction device through inlet valves, of which one of the inlet valves is opened, and another of inlet valves is closed.

11. The apparatus of claim 9, further comprising a pressure regulating system, wherein the pressure regulating system is configured to introducing a second solvent into the kettle container communicated with the tubular reaction device and the kettle reaction device, a first pressure inside the tubular reaction device and a second pressure inside the kettle reaction device are kept substantially the same as a predetermined pressure by evaporation of the second solvent.

12. The apparatus of claim 1, further comprising a material transport system to transport the raw material mixed solution from the raw materials system to the tubular reaction device.

13. The apparatus of claim 12, the material transport system comprises a delivery pump located between the raw material system and the tubular reaction device, and the delivery pump comprises a frequency converter to control a flow rate of the raw material mixed solution.

14. The apparatus of claim 1, the raw material system comprises a mixing container and a first stirrer located in the mixing container.

15. A method for making lithium iron phosphate, comprising steps of:
providing a raw material mixed solution of a hydrothermal reaction or a solvothermal reaction;
making the raw material mixed solution in a plug flowing and reacting state to obtain a reacted material; and
making the reacted material in a complete mixing and reacting state.

16. The method of claim 15, wherein the raw material mixed solution is kept in the plug flowing and reacting state and the complete mixing and reacting state at a temperature in a range from about 0° C. to about 250° C. under a pressure in a range from about 0 MPa to about 2 MPa.

17. The method of claim 15, wherein the raw material mixed solution is kept in the plug flowing and reacting state for a time equal to or no longer than 4 hours.

18. The method of claim 15, wherein the reacted material is kept in the complete mixing and reacting state for a time in a range from about 1 hour to about 10 hours.

19. The method of claim 15, wherein raw material mixed solution is for synthesizing lithium iron phosphate through the hydrothermal reaction or the solvothermal reaction.

20. The method of claim 15, wherein a pressure of a reaction system of the hydrothermal reaction or the solvothermal reaction is regulated by controlling an evaporation of a solvent added to the reaction system.
